(19) United States
(12) Patent Application Publication
(10) Pub. No.: US 2011/0202826 A1
(43) Pub. Date: Aug. 18, 2011

(54) DOCUMENT CREATION SUPPORT APPARATUS AND DOCUMENT CREATION SUPPORTING METHOD THAT CREATE DOCUMENT DATA BY QUOTING DATA FROM OTHER DOCUMENT DATA, AND STORAGE MEDIUM

(75) Inventor: Tomoyuki SHIMIZU, Yokohama-shi (JP)

(73) Assignee: CANON KABUSHIKI KAISHA, Tokyo (JP)

(21) Appl. No.: 13/018,966

(22) Filed: Feb. 1, 2011

(30) Foreign Application Priority Data
Feb. 17, 2010 (JP) 2010-032792
Nov. 26, 2010 (JP) 2010-263866

(51) Int. Cl. G06F 17/00

(52) U.S. Cl. 715/230

(57) ABSTRACT

A document creation support apparatus which, when creating document data by quoting data from other document data, can accurately and efficiently recommend to information related to the data which might need to be additionally quoted to users. Quotation data is quoted from other document data when document data is to be created. At least one of a quotation source and a quotation destination of the quotation data is identified. The quotation data related to the at least one of the quotation source and the quotation destination is obtained, and the obtained quotation data is presented.

### BACKGROUND OF THE INVENTION

1. Field of the Invention

The present invention relates to a document creation support apparatus and a document creation supporting method used to create document data by quoting data from other document data, as well as a computer-readable storage medium storing a program for causing a computer to implement the method.

2. Description of the Related Art

Conventionally, to efficiently create and edit documents, portions such as diagrams and texts which possibly can be reused are searched for from other documents that have already been created, and they are quoted. On the other hand, searching for reusable documents and portions thereof requires a lot of time and effort, and hence techniques to save the time and effort have been proposed. For example, there has been known the technique to obtain the degrees of similarities between documents and body texts and present similar documents because it is highly possible that there are quotable portions in documents similar in content (see, for example, Japanese Laid-Open Patent Publication (Kokai) No. 2003-308314).

However, in general, even when portions such as diagrams and texts are quoted in document creation, information related to the quoted portions is further required in many cases. For example, when a diagram is included in a document, a text for describing the diagram may be required. On the other hand, according to the conventional method, an object to be quoted itself or a document including the same is merely presented. For this reason, it is necessary to additionally search for information related to the object to be quoted. Namely, to search for information related to an object to be quoted matching the purpose of document creation and contexts, it is necessary to consider search conditions and select desired ones from search results, which requires additional time and effort.

### SUMMARY OF THE INVENTION

The present invention provides a document creation support apparatus and a document creation supporting method which, when creating document data by quoting data from other document data, accurately and efficiently recommend to users information related to the data which might need to be additionally quoted, as well as a computer-readable storage medium storing a program for causing a computer to implement the method.

Accordingly, a first aspect of the present invention provides a document creation support apparatus comprising a designation unit configured to designate quotation data to be quoted from other document data when document data is to be created, an identifying unit configured to identify at least one of a quotation source and a quotation destination of the quotation data designated by the designation unit, an obtainment unit configured to obtain the quotation data related to the at least one of the quotation source and the quotation destination identified by the identifying unit, and a presentation unit configured to present the quotation data obtained by the obtainment unit.

Accordingly, a second aspect of the present invention provides a document creation supporting method comprising a designation step of designating by a designation unit quotation data to be quoted from other document data when document data is to be created, an identifying step of identifying by an identifying unit at least one of a quotation source and a quotation destination of the quotation data designated in the designation step, an obtainment step of obtaining by an obtainment unit the quotation data related to the at least one of the quotation source and the quotation destination identified in the identifying step, and a presentation step of presenting by a presentation unit the quotation data obtained in the obtainment step.

Accordingly, a third aspect of the present invention provides a computer-readable non-transitory storage medium storing a program for causing a computer to execute a document creation supporting method, the method comprising a designation step of designating quotation data to be quoted from other document data when document data is to be created, an identifying step of identifying at least one of a quotation source and a quotation destination of the quotation data designated in the designation step, an obtainment step of obtaining the quotation data related to the at least one of the quotation source and the quotation destination identified in the identifying step, and a presentation step of presenting the quotation data obtained in the obtainment step.

According to the present invention, when document data is to be created by quoting data from other document data, information related to the data which might need to be additionally quoted can be accurately and efficiently recommended to users.

Further features of the present invention will become apparent from the following description of exemplary embodiments (with reference to the attached drawings).

### BRIEF DESCRIPTION OF THE DRAWINGS

FIGS. 1A and 1B are block diagrams schematically showing a circuit arrangement of a document creation support apparatus according to an embodiment of the present invention.

FIG. 2 is a diagram schematically showing a functional arrangement of the document creation support apparatus according to the embodiment of the present invention.

FIG. 3 is a flowchart of a process carried out by the document creation support apparatus according to the embodiment of the present invention.

FIG. 4 is a diagram useful in explaining an exemplary relationship between logical portions in a document managed by an in-document relationship management unit.

FIG. 5 is a diagram useful in explaining exemplary quotation information indicative of a quotation source and a quotation destination managed by a quotation information management unit.

FIG. 6 is a diagram useful in explaining a recommendation candidate selection process carried out by a recommendation candidate selection unit.

FIG. 7 is a diagram showing a state in which a recommendation candidate is presented close to a quotable position on a document being created.

FIG. 8 is a diagram showing an exemplary arrangement of quotation information.

FIG. 9 is a diagram showing exemplary defined logical structures and logical relationships.

FIG. 10 is a diagram showing an example where a logical structure that is not defined in a quotation destination is included in a quotation source.

FIG. 11 is a diagram showing an example where a logical structure that is not defined in a quotation destination is included in a quotation source.

FIG. 12 is a diagram showing an example where a plurality of types of logical portions are made recommendation candidates.

FIG. 13 is a diagram showing an example where a plurality of types of logical portions are made recommendation candidates.

### DESCRIPTION OF THE EMBODIMENTS

Preferred embodiments to which the present invention is applied will now be described in detail with reference to the accompanying drawings.

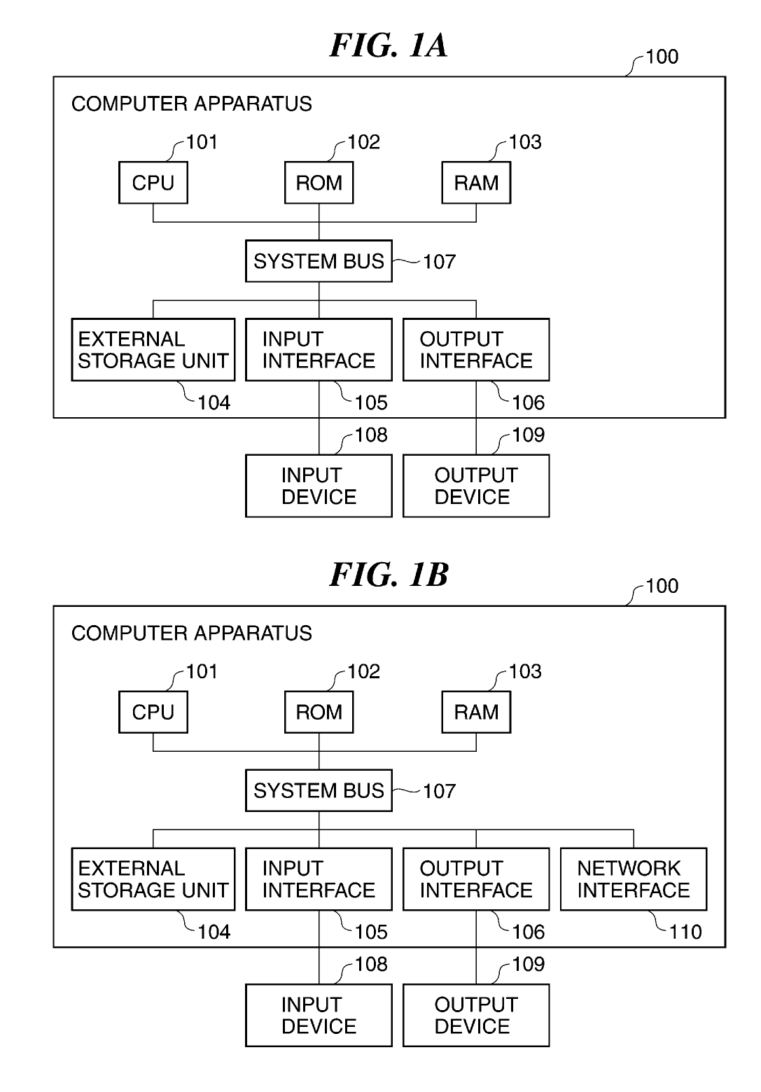

First, a description will be given of a first embodiment of the present invention. FIGS. 1A and 1B are block diagrams schematically showing a circuit arrangement of a document creation support apparatus according to the first embodiment of the present invention. The arrangement of the document creation support apparatus according to the present embodiment may be realized by a single computer apparatus, or may be realized by a plurality of computer apparatuses by distributing functions to them as the need arises. FIG. 1A shows a case where a single computer apparatus constitutes the document creation support apparatus according to the present embodiment. When a plurality of computer apparatuses constitute the document creation support apparatus according to the present embodiment, a network interface 110 is added to the arrangement shown in FIG. 1A as shown in FIG. 1B, and the computer apparatuses are connected together via a LAN (local area network) or the like for communication with each other.

In FIGS. 1A and 1B, a reference numeral 101 designates a CPU (central processing unit) that controls the overall operation of the document creation support apparatus 100. A reference numeral 102 designates a ROM (read-only memory) that stores programs and parameters that are not required to be changed. A reference numeral 103 designates a RAM (random-access memory) that temporarily stores programs and data supplied from an external storage unit 104 and the like. The external storage unit 104 includes a hard disk drive (HDD), a flash memory drive (SSD), or the like fixedly installed in the document creation support apparatus 100, or a memory card, an optical disk, or the like removable from the document creation support apparatus 100. A reference numeral 105 designates an interface (input interface) that interfaces with an input device 108 such as a pointing device, a keyboard, or the like which inputs data in response to user's operations. A reference numeral 106 designates an interface (output interface) that interfaces with an output device 109 such as a monitor for outputting data held by the document creation support apparatus 100, data supplied to the document creation support apparatus 100, and results of program execution by the document creation support apparatus 100. A reference numeral 107 designates a system bus that connects the units 101 to 106 together for communication with each other.

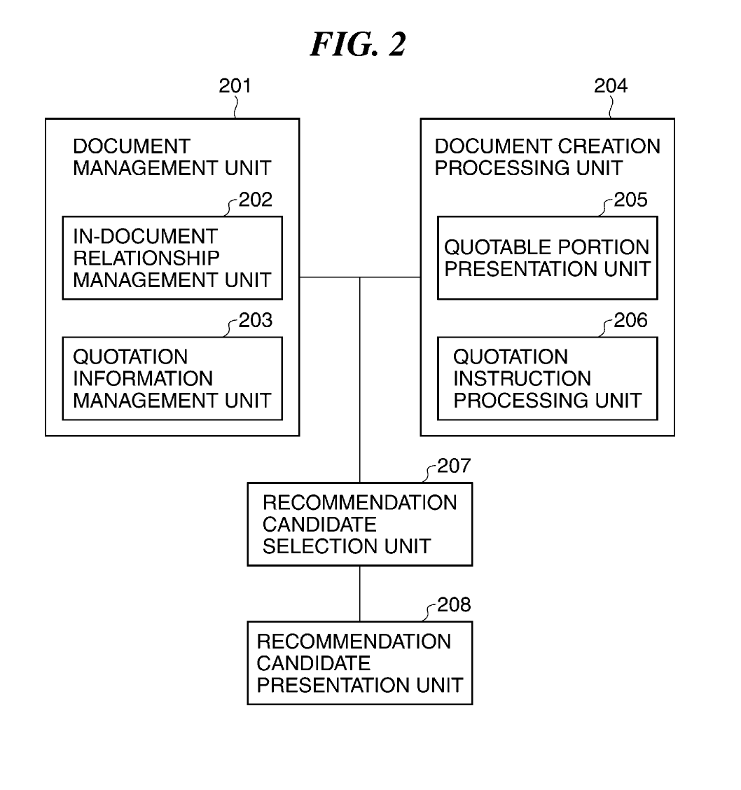

FIG. 2 is a diagram schematically showing a functional arrangement of the document creation support apparatus according to the present embodiment. The functional arrangement described below is realized by the CPU 101 executing programs loaded from the external storage unit 104 into the RAM 103.

In FIG. 2, a reference numeral 201 designates a document management unit including an in-document relationship management unit 202 and a quotation information management unit 203, described later. The document management unit 201 manages identifiers of document data (hereafter merely referred to as documents), identifiers of logical portions in the documents, and information managed by the in-document relationship management unit 202 and the quotation information management unit 203 in such a manner that they can be obtained. It should be noted that logical portions mean, for example, photographs, texts written as descriptions thereof, and blocks for placing them.

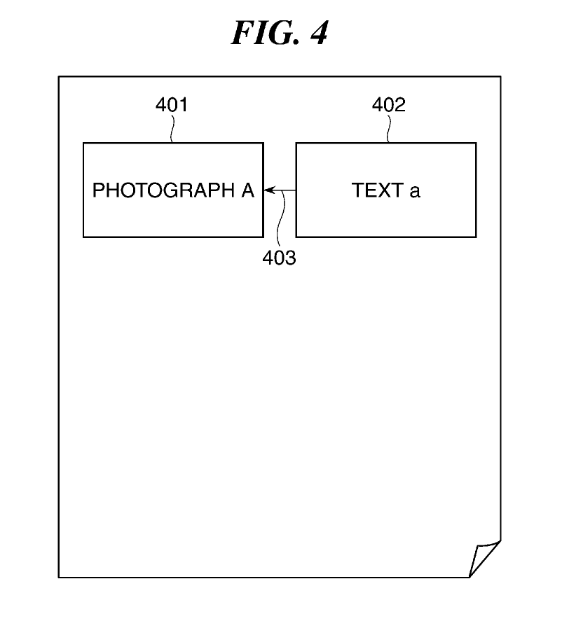

The in-document relationship management unit 202 manages the relationship between logical portions in documents. For example, when there are a photograph A 401 and a text a 402 written as a description thereof in a document as shown in FIG. 4, the in-document relationship management unit 202 manages the relationship between the photograph A 401 and the text a 402 (the in-document relationship). An arrow designated by a reference numeral 403 conceptually indicates that a logical portion at a rear end (the text a 402) describes a logical portion at a front end (the photograph A 401). By managing the arrow 403, the in-document relationship management unit 202 manages the relationship that “the text a 402 describes the photograph A 401” in a recognizable manner. It should be noted that in the present embodiment, a document creation processing unit 204, described later, creates a document using a template in which structures of logical portions (logical structures) and relationships therebetween (logical relationships) are defined. Namely, a document is created in accordance with logical structures and logical relationships defined in a template, and the logical structures and the logical relationships have been made clear when the document is created. Thus, the in-document relationship management unit 202 has only to manage the defined logical structures and logical relationships. FIG. 9 shows an example thereof. Referring to FIG. 9, a column of related objects is comprised of logic portions of relating destinations among logical portions, and a column of relating objects is comprised of logic portions of relating sources among logical portions. A column of identifiers is comprised of information that identifies logical relationships between logical portions. Referring to FIG. 9, these “logical portions of relating sources”, “logical portions of relating destinations”, and “descriptions of logical relationships” are managed on a line-by-line basis. In the example illustrated in FIG. 4, a document with a document ID “δ” in a line 901 corresponds to the document in FIG. 4, and logical portion identifiers “001” and “002” corresponds to the photograph A 401 and the text a 402, respectively. Also, the “descriptive relationship” corresponds to the arrow 403. It should be noted that although in FIG. 9, a plurality of documents are collectively managed, the present invention is not limited to this. Also, logical portions and their relationship may be managed on a document-by-document basis. On the other hand, the method to describe logical structures and logical relationships has only to be any method that can describe logical portions and their relationships as shown in FIG. 9, and they may be stored in a commonly-used description such as RDF/XML which can describe logical relationships, or may be stored in an RDB (relational database) that defines a schema such as the table of FIG. 9. Moreover, it is preferred that vocabulary representing logical relationships such as the “descriptive relationship” is unified so as to be reused in cases where, for example, the same logical relationships are searched for. Thus, standard vocabulary definitions such as Dublin Core may be used.

The quotation information management unit 203 manages quotation information indicative of a quotation source and a quotation destination with respect to a logical portion as an object to be quoted when the logical portion is quoted. For example, in a case where a photograph 502 in a document 501 is quoted in a photograph placement block X 504 of a document 503 being created, information that “the photograph 502 in the document 501 is a quotation source, and the photograph placement block X 504 of the document 503 is a quotation destination” is quotation information.

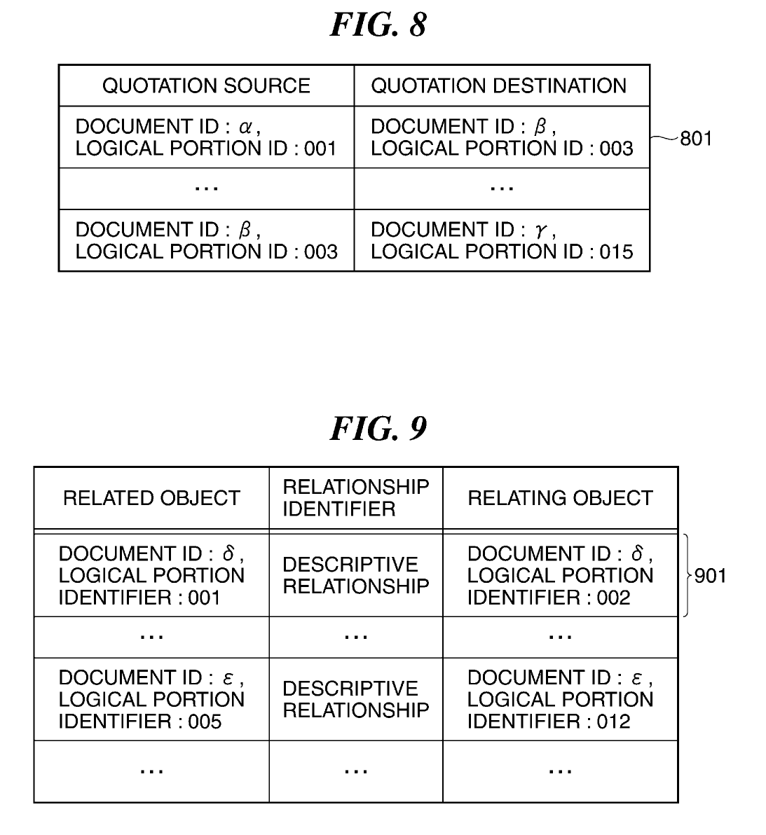

Because such a quotation relationship has only to be shown in a recognizable manner, quotation information is, for example, as shown in FIG. 8. FIG. 8 is a diagram showing exemplary quotation information that expresses the relationships between quotation sources and quotation destinations in a recognizable manner using identifiers of documents managed by the document management unit 201 and identifiers of logical portions in the documents. Whenever a logical portion is quoted, the quotation information management unit 203 creates and manages such quotation information. For example, quotation information 801 shown in FIG. 8 indicates that a logical document with a logical portion ID “001” in a document with a document ID “α” is quoted as a logical document with a logical portion ID “003” in a document with a document ID “β”.

The document creation processing unit 204 includes a quotable portion presentation unit 205 and a quotation instruction processing unit 206, described later. The document creation processing unit 204 creates documents while quoting logical portions. It should be noted that in the present embodiment, documents are created using templates in which logical portions and the relationships between the logical portions are defined in advance. In the present embodiment, the templates are managed by the document creation processing unit 204. In the templates, physical configuration information such as positional information on blocks used when printing, and logical configuration information indicative of, for example, what is placed in the blocks. However, according to the present invention, the templates have only to include information that defines the logical relationship between blocks, and may include or not include other information. Moreover, description formats of information defined in the templates are not limited. For example, information defined in the templates has only to be held in formats such as XML which enable structured information to be written.

The quotable portion presentation unit 205 presents quotable logical portions to the output device 109 via the output interface 106. Quotable logical portions presented in the present embodiment are selected by the quotable portion presentation unit 205 receiving search conditions designated by a user, and performing a search for logical portions matching the search conditions with respect to the document management unit 201. The present invention is not limited to this, but the search conditions may be information obtained by analyzing information input by the user during document creation, not search conditions directly designated by the user.

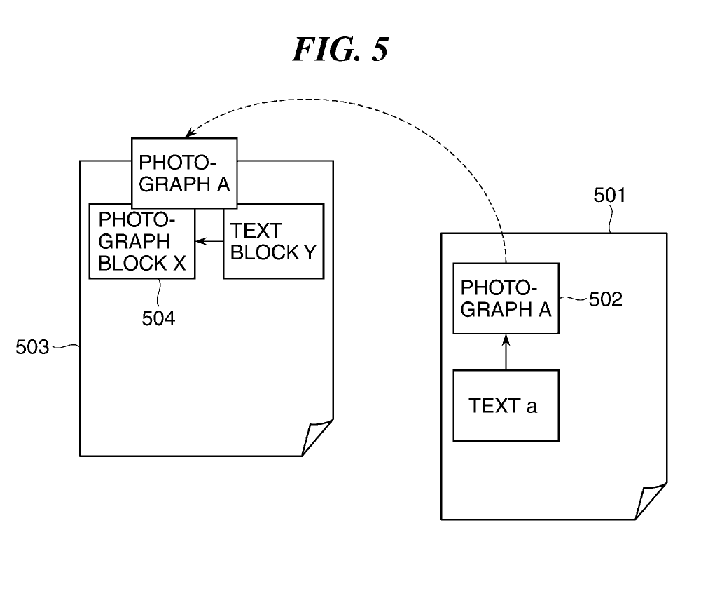

The quotation instruction processing unit 206 carries out a process to receive a user's designation of a logical portion presented by the quotable portion presentation unit 205 and a user's instruction to quote the logical portion in a document being created, and quote the designated logical portion in the document. In the present embodiment, because a template is used for document creation, the quotation instruction processing unit 206 receives an instruction to quote a logical portion designated by the user in the logical portion on the template. In the example illustrated in FIG. 5, the quotation instruction processing unit 206 receives an operational instruction to quote the photograph 502 of the document 501 in the photograph placement block 504 of the document 503.

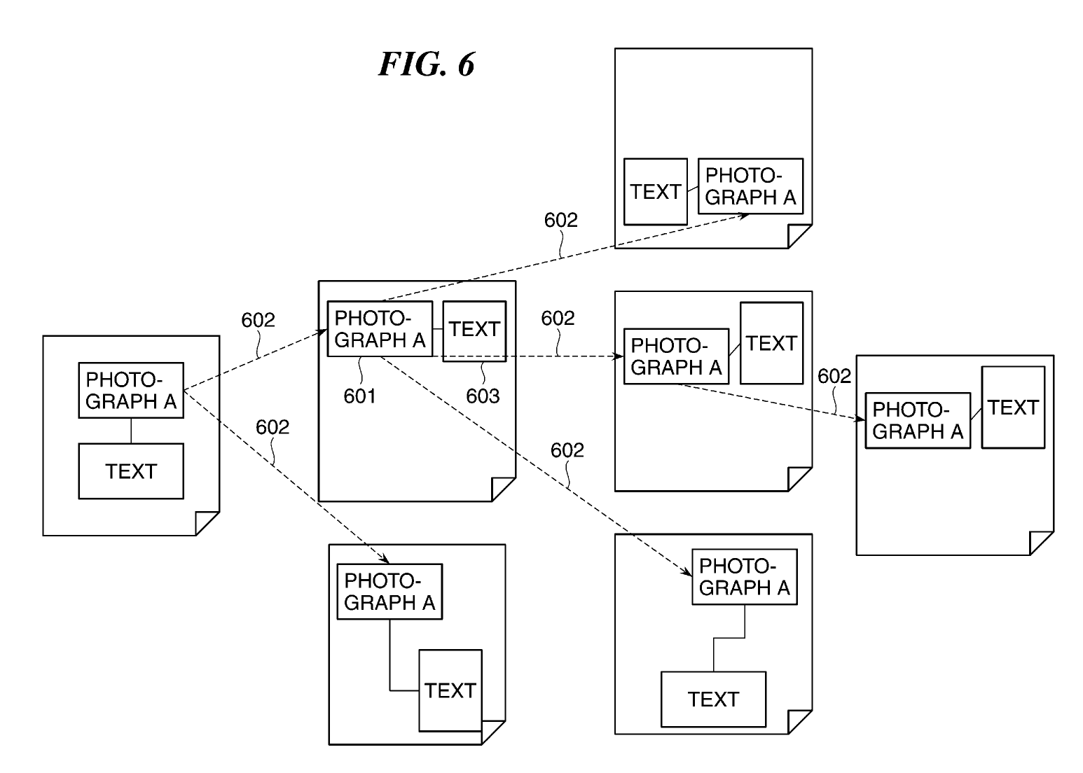

A reference numeral 207 designates a recommendation candidate selection unit that, when quotation of a logical portion is instructed during document creation, selects as a recommendation candidate another logical portion (related portion) that might need to be quoted together with the logical portion to be quoted. The recommendation candidate selection unit 207 traces quotation information which the logical portion designated as an object to be quoted has, and selects logical portions having in-document relationships with respective quotation sources and quotation destinations as recommendation candidates. The number of information indicative of quotation sources and quotation destinations increases with document creation, and accordingly, the range for and way of tracing grow in scale. Thus, tracing all quotation sources and quotation destinations and selecting them as recommendation candidates is unrealistic in terms of the time required for searching and the number of recommendation candidates. Thus, in the present embodiment, the range for and way of tracing quotation sources and quotation destinations are set in advance, and recommendation candidates are selected in accordance with the settings. The set information has only to be one that can roughly limit the scope of recommendation candidates obtained by tracing. For example, it may be arranged such that tracing is performed in such a range that quotation information is traced twice from a starting point which is a logical portion designated as an object to be quoted, and in both directions of a quotation source and a quotation destination. The process to select recommendation candidates in this example will now be described with reference to FIG. 6. In FIG. 6, a reference numeral 601 designates a photograph of a logical portion as a starting point. Reference numerals 602 designate quotation relationships between logical portions indicated by quotation information. A reference numeral 603 designates a text in which a description of the photograph 601 is written, and which has an in-document relationship with the photograph 601. FIG. 6 shows a state in which quotation relationships are traced in such a range that quotation information can be traced twice starting on the photograph 601. In this manner, the recommendation candidate selection unit 207 traces quotation relationships indicated by quotation information, and selects texts having in-document relationships with respective photographs as recommendation candidates.

It should be noted that when the number of selected recommendation candidates is large, selecting recommendation candidates requires a lot of time and effort, and hence in the present embodiment, selected recommendation candidates are ranked. Moreover, in the present embodiment, because a template includes layout definitions, recommendation candidates that require fewer layout changes can be ranked higher. For example, in a case where texts in which a description of a photograph is written are selected as recommendation candidates as described above, layout has to be adjusted according to volumes of the texts when the texts are quoted in a template because in general, volumes vary from document to document. Thus, in the present embodiment, recommendation candidates are ranked so that texts fitting in a template in just proportion according to a layout defined in the template are given higher priorities.

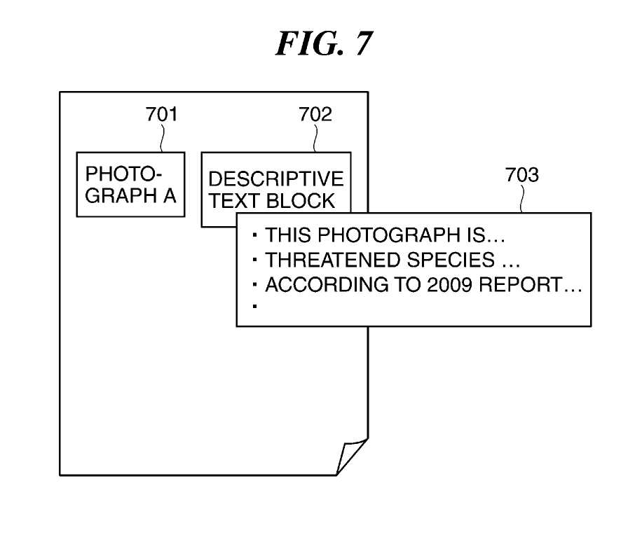

A reference numeral 208 designates a recommendation candidate presentation unit that outputs recommendation candidates selected by the recommendation candidate selection unit 207 to the output device 109 via the output interface 106. In a case where the recommendation candidates have been ranked by the recommendation candidate selection unit 207, the recommendation candidate presentation unit 208 preferentially presents higher-ranked ones of the recommendation candidates. It should be noted that the way of presenting recommendation candidates is not limited, but in the present embodiment, recommendation candidates are presented close to positions at which they are quotable in a document being created. FIG. 7 is a diagram showing a state in which recommendation candidates are presented close to quotable positions on a document being created. In FIG. 7, a reference numeral 701 designates a photograph A quoted in a template, and a reference numeral 702 designates a descriptive text block in which a text describing the photograph A 701 is placed on the template. On this occasion, when a text 703 is made a higher-ranked recommendation candidate, the text 703 is presented near (close to) the descriptive text block 702 because the descriptive text block 702 is a place at which the text 703 as the recommendation candidate is desired to be quoted.

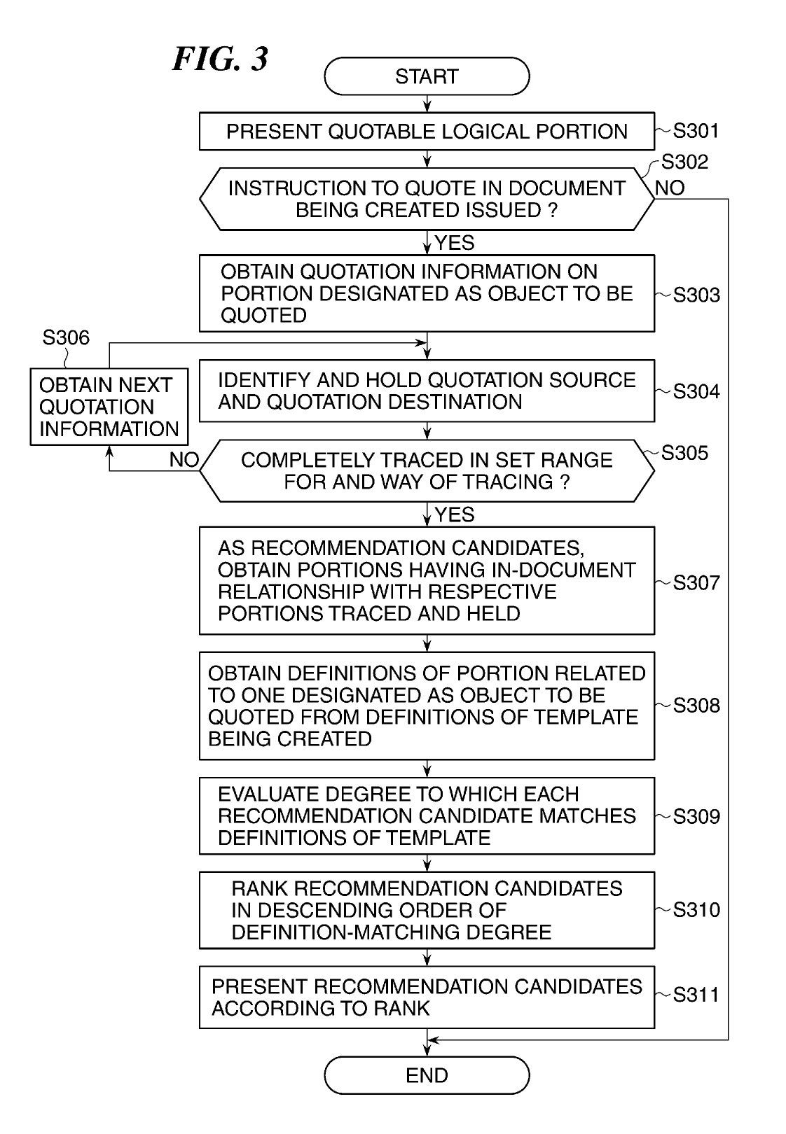

FIG. 3 is a flowchart of a process carried out by the document creation support apparatus according to the present embodiment. In the process, when a logical portion is to be quoted in document creation, related portions that might need to be quoted together with the logical portion are recommended. Referring to FIG. 3, a detailed description will now be given of the process carried out by the document creation support apparatus according to the present embodiment.

In step S301, the quotable portion presentation unit 205 presents a quotable logical portion. Then, in step S302, the quotation instruction processing unit 206 determines whether or not an instruction to quote the presented logical portion in a template for a document being created has been issued. When the instruction has not been issued, the process is terminated without performing anything particular in the present flow. On the other hand, when the instruction has been issued, the process proceeds to step S303. It should be noted that the process in the step S302 in which the designation of a logical portion to be quoted is received from the user, and the logical portion is designated as an object to be quoted is an exemplary process carried out by a designation unit of the present invention.

As explained hereafter, by carrying out processes from the step S303 through step S310, the recommendation candidate selection unit 207 selects and ranks recommendation candidates. Specifically, in the step S303, the recommendation candidate selection unit 207 obtains quotation information on the logical portion designated in the step S302 from the quotation information management unit 203. In the next step S304, the recommendation candidate selection unit 207 identifies quotation sources and quotation destinations of the logical portion from the quotation information obtained in the step S303, and holds the same. It should be noted that the step S304 is an exemplary process carried out by an identifying unit of the present invention.

In the next step S305, the recommendation candidate selection unit 207 determines whether or not the quotation sources and the quotation destinations of the logical portion have completely been traced in a set range and way of tracing. When the quotation sources and the quotation destinations of the logical portion have completely been traced, the process proceeds to the step S307. On the other hand, when the quotation sources and the quotation destinations of the logical portion have not completely been traced, the process proceeds to step S306. In the step S306, the recommendation candidate selection unit 207 further obtains quotation information associated with logical portions at the obtained quotation sources and quotation destinations, and returns to the step S304. By repeatedly carrying out the processes from the step S304 to the step S306, the recommendation candidate selection unit 207 identifies quotation sources and quotation destinations by tracing, in a set range and way of tracing them starting on the logical portion designated as an object to be quoted.

In the step S307, with the quotation sources and the quotation destinations identified by tracing, the recommendation candidate selection unit 207 obtains respective logical portions having in-document relationships from the in-document relationship management unit 202. The logical portions thus obtained are recommendation candidates. In the next step S308, the recommendation candidates selection unit 207 obtains definitions of a logical portion (block) related to the logical portion designated as an object to be quoted in the step S302 from definitions of a template for the document being created. In the present embodiment, it is assumed that as definitions of the logical portion, at least a logical structure of the logical portion is obtained.

In the next step S309, the recommendation candidate selection unit 207 evaluates degrees to which the recommendation candidates obtained in the step S307 match the definitions of the logical portion obtained in the step S308. In the next step S310, the recommendation candidate selection unit 207 ranks the recommendation candidates according to the degrees of matching (evaluation results) evaluated in the step S309. In the next step S311, the recommendation candidate presentation unit 208 presents the selected and ranked recommendation candidates in the processes up to the step S310. It should be noted that the step S309 is an exemplary process carried out by an evaluation unit of the present invention, and the step S311 is an exemplary process carried out by a presentation unit of the present invention.

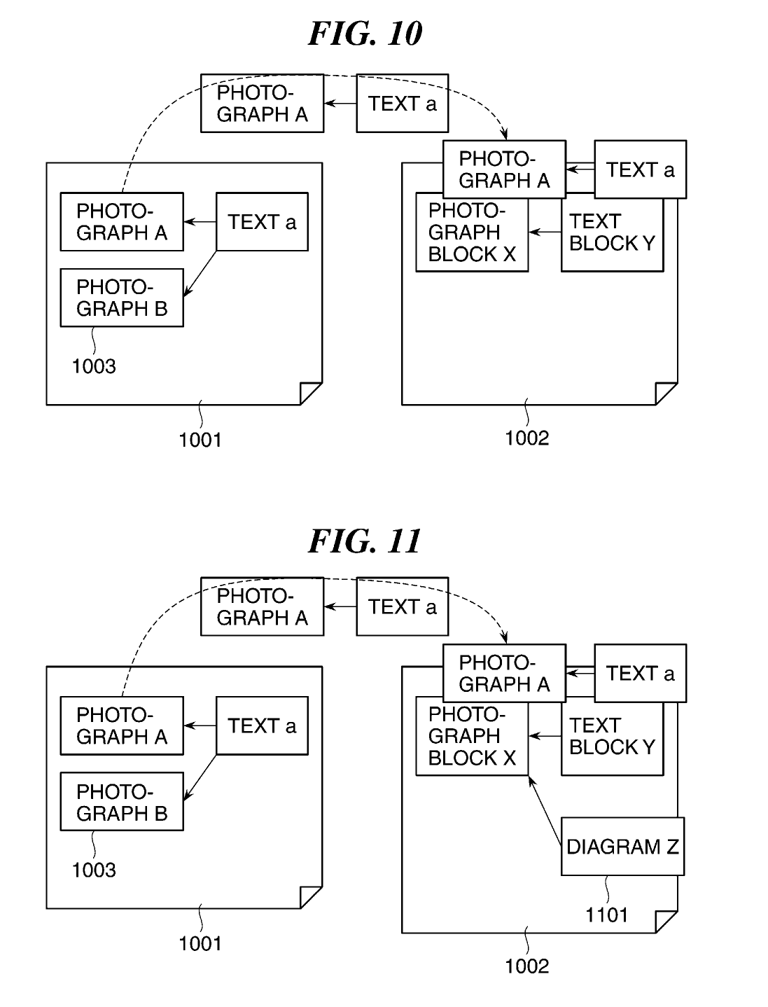

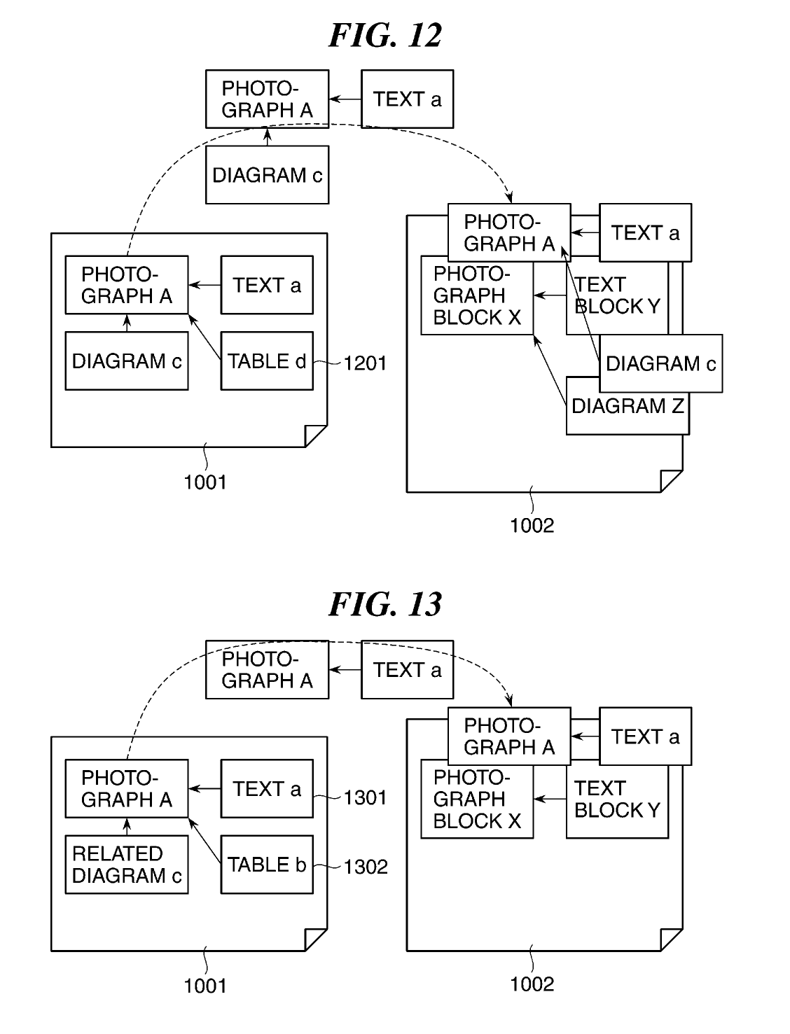

Next, a description will be given of a second embodiment of the present invention. It should be noted that arrangements of document creation support apparatuses according to the second to sixth embodiments described below are the same as the arrangement shown in FIGS. 1A, 1B, and 2. In the above description of the first embodiment, one designated as an object to be quoted is a photograph, and one having an in-document relationship with the photograph is a text, but there is no essential difference even if they are reversed. Namely, in the second embodiment, when a logical portion designated as an object to be quoted is a text, a photograph is presented as a recommendation candidate having an in-document relationship with the text. Such combinations are not limited by types such as photographs and texts, but may be anything such as tables and diagrams as long as they have logical chunks. Moreover, those logical portions have only to have obtainable in-document relationships. For example, if one designated as an object to be quoted is an image, it has an in-document relationship with another image which is a description of the image, and blocks are defined so that the image and the other image describing the same can be placed on a template, the other image may be presented as a recommendation candidate. Moreover, although in the above described first embodiment, logical portions have a one-to-one relationship in a document as a quotation source, and they also have a one-to-one relationship in definitions of a template as a quotation destination, the present invention is not limited to this. Logical portions may have an n-to-n (n≧1) relationship in either one or both of a document and a template. In this case, there may be logical relationships and/or logical portions that are not defined in both, but they are ignored. FIGS. 10 and 11 show examples where a logical portion that is not defined in a template 1002 as a quotation destination is included in a document 1001 as a quotation source. In this case, the logical portion 1003 that is not defined in the template in a document as a quotation source as the quotation destination is ignored. Also, in the example illustrated in FIG. 11, a logical relationship and a logical portion defined in the template as the quotation destination are not included in the document as the quotation source. In this case, a logical portion 1101 that is not included in the quotation source is ignored. FIG. 12 shows an example where a plurality of types of logical portions are recommendation candidates. In this case as well, a logical portion 1201 of a type that is not defined in a quotation destination is ignored. It should be noted that as shown in FIG. 13, there may be cases where a plurality of logical portions 1301 and 1302 defined in a template as a quotation destination are included as logical portions in a document as a quotation source.

In this case, any logical portion may be selected, or a plurality of logical portions may be merged into one and selected. In the example illustrated in FIG. 13, a “text a” 1301 and a “text b” 1302 can be made recommendation candidates, but only the former is selected. When any one is selected like this, priorities may be assigned to logical portions, and any one of them may be selected according to the priorities. In this case, it is assumed that the priorities are defined in a template. Alternatively, a keyword may be extracted from a text of a template as a quotation destination, and a candidate closer in content to the entire document as the quotation destination may be selected by, for example, evaluating the content percentage of the keyword and the conceptual closeness to the keyword.

Next, a description will be given of the third embodiment of the present invention. In the first and second embodiments described above, there are no differences in vocabulary indicative of in-document relationships, but actually, there may be vocabulary with various definitions. In such cases, it is necessary to create a mechanism for absorbing differences in vocabulary. For example, differences in vocabulary may be absorbed using something like a conceptual dictionary. However, when there are both a relationship in which vocabulary matches and a relationship in which concepts are considered to be the same, candidates having the former relationship may be ranked higher.

Next, a description will be given of the fourth embodiment of the present invention. In the above description of the first to third embodiments, because a template is used, a logical structure has been made clear at the time of document creation. However, all documents cannot always be created using such templates. For example, when a document is written in a language such as XML which can describe a logical structure, an in-document relationship may be managed by analyzing the logical structure. In this case, it is assumed that rules required for analyzing the logical structure are made in advance. Moreover, the present invention is not limited to this, but for example, structures and relationships may be extracted by analyzing the layout of photographs and text blocks from a looking viewpoint.

Next, a description will be given of the fifth embodiment of the present invention. In the above description of the first to fourth embodiments, a range for and a way of tracing quotation information are set in advance by the candidate selection unit 207. However, the present invention is not limited to this, but a range for and a way of tracing may be dynamically set on a case-by-case basis according to limitations on display regions, resource usage, and so on.

Next, a description will be given of the sixth embodiment of the present invention. The number of times each of traced quotation sources and quotation destinations has been quoted before may be determined from quotation information managed by the quotation information management unit 203, and logical portions that have been quoted more times may be higher-ranked recommendation candidates. Alternatively, the number of times each logical portion itself as a recommendation candidate has been quoted before may be determined, and used for ranking. It should be noted that processes to determine the number of times each of quotation sources and quotation destinations has been quoted before, and the number of times each logical portion as a recommendation candidate has been quoted before are exemplary processes carried out by a determination unit of the present invention.

As is clear from the above description, according to the above described embodiments, when a logical portion is quoted from another document in document creation and edition, information related to the logical portion which might need to be additionally quoted can be accurately and efficiently recommended to users.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-032792 filed Feb. 17, 2010 and No. 2010-263866 filed Nov. 26, 2010, which are hereby incorporated by reference herein in their entirety.

What is claimed is:

1. A document creation support apparatus comprising:
a designation unit configured to designate quotation data to be quoted from other document data when document data is to be created;
an identifying unit configured to identify at least one of a quotation source and a quotation destination of the quotation data designated by said designation unit;
an obtainment unit configured to obtain the quotation data related to the at least one of the quotation source and the quotation destination identified by said identifying unit; and
a presentation unit configured to present the quotation data obtained by said obtainment unit.

2. A document creation support apparatus according to claim 1, further comprising:
an evaluation unit configured to evaluate a degree to which each piece of the quotation data obtained by said obtainment unit matches definitions set in a template for the document data,
wherein said presentation unit presents each piece of the quotation data obtained by said obtainment unit using a presentation method based on results of evaluation by said evaluation unit.

3. A document creation support apparatus according to claim 1, further comprising:
another evaluation unit configured to evaluate, with respect to each piece of the quotation data obtained by said obtainment unit, a degree to which a structure at a position of each piece of the quotation data in the document data in which each piece of the quotation data is quoted matches a structure of each piece of the quotation data,
wherein said presentation unit presents each piece of the quotation data obtained by said obtainment unit using a presentation method based on results of evaluation by said other evaluation unit.

4. A document creation support apparatus according to claim 1, further comprising:
a determination unit configured to determine the number of times at least one of the quotation source and the quotation destination identified by said identifying unit has been quoted before,
wherein said presentation unit presents each piece of the quotation data obtained by said obtainment unit using a presentation method based on the number of times determined by said determination unit.

5. A document creation support apparatus according to claim 1, further comprising:
another determination unit configured to determine the number of times each of the quotation data obtained by said obtainment unit has been quoted before,
wherein said presentation unit presents each piece of the quotation data obtained by said obtainment unit using a presentation method based on the number of times determined by said other determination unit.

6. A document creation support apparatus according to claim 1, wherein said obtainment unit determines a relationship between the quotation data in the created document data or the other document data by analyzing a logical structure of the created document data or the other document data, and obtains quotation data related to at least one of the quotation source and the quotation destination identified by said identifying unit.

7. A document creation support apparatus according to claim 1, wherein by using a template for the created document data or the other document data in which a relationship between quotation data is defined, said obtainment unit obtains quotation data related to at least one of the quotation source and the quotation destination identified by said identifying unit.

8. A document creation support apparatus according to claim 1, wherein said presentation unit presents the quotation data obtained by said obtainment unit in proximity to a position at which the equation data is quoted in the document data.

9. A document creation supporting method comprising:
a designation step of designating by a designation unit quotation data to be quoted from other document data when document data is to be created;
an identifying step of identifying by an identifying unit at least one of a quotation source and a quotation destination of the quotation data designated in said designation step;
an obtainment step of obtaining by an obtainment unit the quotation data related to the at least one of the quotation source and the quotation destination identified in said identifying step; and
a presentation step of presenting by a presentation unit the quotation data obtained in said obtainment step.

10. A computer-readable non-transitory storage medium storing a program for causing a computer to execute a document creation supporting method, the method comprising:
a designation step of designating quotation data to be quoted from other document data when document data is to be created;
an identifying step of identifying at least one of a quotation source and a quotation destination of the quotation data designated in the designation step;
an obtainment step of obtaining the quotation data related to the at least one of the quotation source and the quotation destination identified in the identifying step; and
a presentation step of presenting the quotation data obtained in the obtainment step.
